(19) United States
(12) Patent Application Publication
(10) Pub. No.: US 2005/0026586 A1
(43) Pub. Date: Feb. 3, 2005

(54) Radio receiver for vehicle and control method thereof

(76) Inventor: Keun-Ho Yang, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,207

(22) Filed: Dec. 30, 2003

(30) Foreign Application Priority Data
Jul. 28, 2003 (KR) 10-2003-0051954

(51) Int. Cl. H04B 1/06

(52) U.S. Cl. 455/277.2; 455/226.2; 455/280

(57) ABSTRACT

A radio receiver for a vehicle and a control method thereof is disclosed. The radio receiver includes a diversity receiver module coupled to multiple antennas. The diversity receiver module is configured to select a first wave signal from a first antenna to be provided as input into an audio system. A comparator compares the intensity of the first radio wave signal to a reference value. Based on the results of the comparison, the comparator signals the diversity receiver module to select a second radio wave signal from a second antenna to be provided as input the audio system.

### CROSS-REFERENCE TO RELATED APPLICATIONS

This application claims the benefit of priority of Korean Application No. 10-2003-0051954, filed on Jul. 28, 2003, the disclosure of which is incorporated fully herein by reference.

### FIELD OF THE INVENTION

The present invention relates to a radio receiver applied with a diversity system for a vehicle and a control method thereof.

### BACKGROUND OF THE INVENTION

In luxury vehicles, a diversity system is generally used for improving radio reception. A typical diversity system is a switching system which divides a pattern of Frequency Modulation (FM) reception of a glass antenna into a main antenna (FM1) and a sub antenna (FM2). The received radio waves for each antenna are compared and the radio wave having the higher intensity value is selected as output. The diversity system, therefore, replaces the received value of the main antenna by that of the sub antenna in a zone where the wave intensity of the main antenna is relatively low due to a geographical ground.

An Automatic Gain Control (AGC) circuit is also used in a radio receiver for a vehicle. The AGC circuit prevents waves from being entangled or overloaded in a strong wave zone. Thus, once a wave is received over a certain intensity, the AGC circuit activates an attenuating circuit in order to decrease an audio system input value.

While such a conventional system has its advantages, the use of a diversity system in combination with an AGC circuit results in a complex configuration having a high manufacturing cost.

Accordingly, what is needed is a radio receiver and control method thereof for a vehicle that can decrease the intensity of a radio wave received by an audio system without an AGC circuit.

### SUMMARY OF THE INVENTION

A radio receiver for a vehicle and a control method thereof is disclosed. The radio receiver includes a diversity receiver module coupled to multiple antennas. The diversity receiver module is configured to select a first wave signal from a first antenna to be provided as input into an audio system. A comparator compares the intensity of the first radio wave signal to a reference value. Based on the results of the comparison, the comparator signals the diversity receiver module to select a second radio wave signal from a second antenna to be provided as input the audio system.

In some embodiments, a radio receiver system comprises: a plurality of antennas each adapted to receive a radio wave signal; a diversity receiver module coupled to the antennas and configured to select a first radio wave signal from a first antenna to be provided as input to an audio system; and a comparator coupled to the diversity receiver module and configured to compare the first radio wave signal with a reference value, and responsive to the comparison, signaling the diversity receiver module to select a second radio wave signal from a second antenna to be provided as input into the audio system.

In some embodiments, a method of controlling a radio receiver, comprises: receiving a plurality of radio wave signals from a plurality of antennas; selecting a first radio wave signal from a first antenna to be provided as input to an audio system; and comparing the first radio wave signal with a reference value, and responsive to the comparison, selecting a second radio wave signal from a second antenna to be provided as input into the audio system.

### BRIEF DESCRIPTION OF THE DRAWINGS

For a better understanding of the nature and objects of the present invention, reference should be made to the following detailed description with the accompanying drawings, in which:

FIG. 1 is a block diagram of a radio receiver for a vehicle according to the present invention; and

FIG. 2 is a flowchart of a control method of a radio receiver for a vehicle according to the present invention.

### DETAILED DESCRIPTION OF THE PREFERRED EMBODIMENTS

The preferred embodiment of the present invention will now be described in detail with reference to the accompanying drawings.

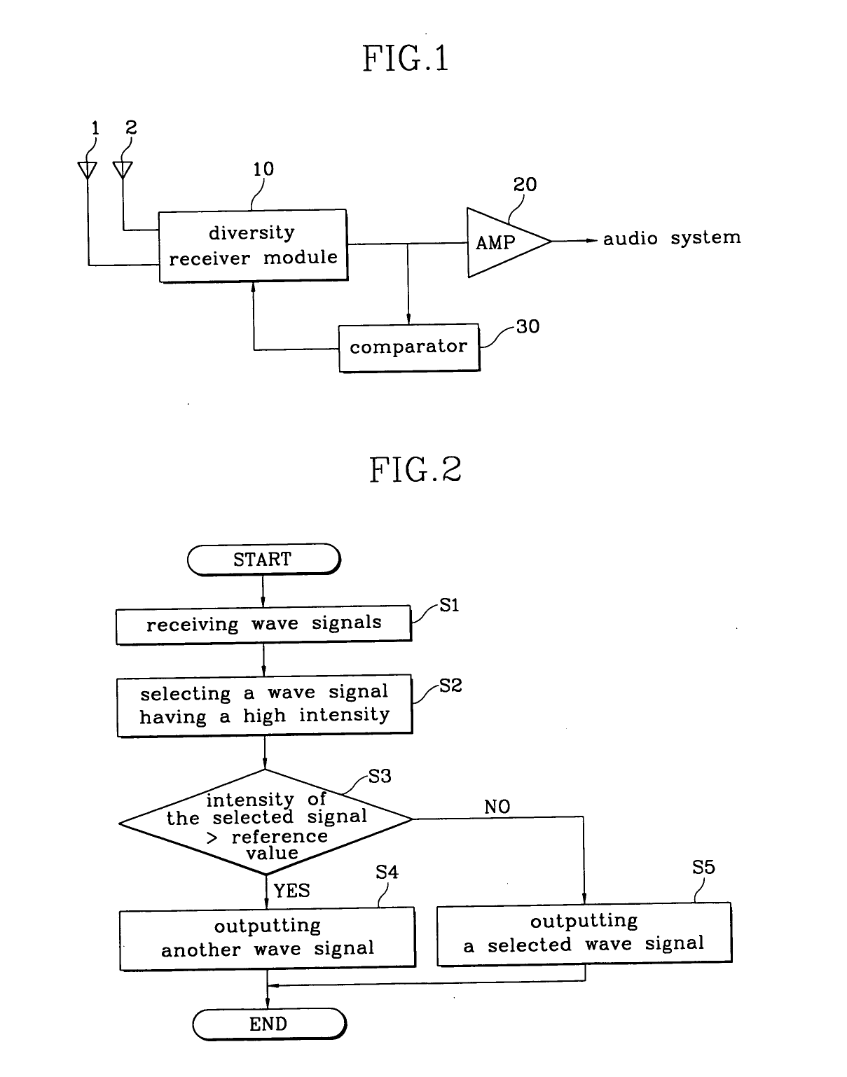

FIG. 1 is a block diagram of a radio receiver for a vehicle. The radio receiver generally includes a main antenna 1, a sub antenna 2, a diversity receiver module 10, a comparator 30 and an amplifier 20. The amplifier 20 output is adapted to be coupled to audio system (not shown). While the radio receiver shown in FIG. 1 includes two antennas, any number of antennas can be used with the present invention.

The diversity receiver module 10 receives radio waves via antennas 1 and 2 and selects a radio wave signal having the strongest intensity for input into an audio system via amplifier 20. The comparator 30 compares a first selected radio wave signal with a predetermined reference value, and provides the result of the comparison to the diversity receiver module 10. The diversity receiver module 10 is configured to select a second radio wave signal from a different antenna based on the result provided by the comparator 30. For example, if the first radio wave signal selected by the diversity receiver module 10 is from the main antenna 1 (i.e., the first radio wave signal from main antenna 1 is higher than the radio wave signal from the sub antenna 2), then the diversity receiver module 10 will select a second radio wave signal from the sub antenna 2 (or a third antenna) and vice-versa.

In some embodiments, the comparator 30 is part of the diversity receiver module 10. In such an embodiment, radio wave signals from both the main antenna 1 and the sub antenna 2 are compared against a predetermined reference value. The radio wave signal having an intensity value that is closest to the reference value but does not exceed the reference value is selected by the diversity receiver module 10 as input into an audio system.

FIG. 2 is a flowchart of a control method of a radio receiver for a vehicle according to the present invention. As shown in FIG. 2, radio wave signals are respectively received at the main antenna 1 and the sub antenna 2 and provided as input into the diversity receiver module 10 (S1). The diversity receiver module 10 selects a first radio wave signal having a high intensity from radio wave signals received through the main antenna 1 and the sub antenna 2, and outputs the selected first radio wave signal via the amplifier 20 to the audio system (S2). The comparator 30 compares the intensity of the first radio wave signal with a predetermined reference value (S3). If the intensity of the first radio wave signal is higher than the reference value, a fourth step is carried out (S4), and if not, a fifth step is performed (S5). Note that the predetermined reference value can be determined empirically based on observation of the radio system during normal operation. Alternatively, the predetermined value can be determined on-the-fly by the diversity receiver module based on received intensities and knowledge of the limitations of the audio system.

In the fourth step, the diversity receiver module 10 outputs a second radio wave signal received from another antenna. For example, if the first radio wave signal selected by the diversity receiver module 10 is from the main antenna 1 (i.e., the first radio wave signal from main antenna 1 is higher than the radio wave signal from the sub antenna 2), then the diversity receiver module 10 will select a second radio wave signal from the sub antenna 2 (or a third antenna) and vice-versa (S4).

The diversity receiver module 10 provides as input to the audio system the signal received via the antenna selected according to the intensity of the first radio wave signal (e.g. if the intensity of the radio wave signal received through the main antenna 1 is higher than that through the sub antenna 2, the signal from the main antenna 1 is chosen, whereas if the intensity of the radio wave signal via the sub antenna 2 is higher than that via the main antenna 1, then the signal received through the sub antenna 2 is chosen) (S5).

As apparent from the foregoing, there is an advantage in that the radio receiver of the present invention decreases the intensity of a radio wave signal provided as input to an audio system without employing an AGC circuit. This results in a simpler configuration and lower manufacturing cost.

1. A radio receiver system, comprising:
a plurality of antennas each adapted to receive a radio wave signal;
a diversity receiver module coupled to the antennas and configured to select a first radio wave signal from a first antenna to be provided as input to an audio system; and
a comparator coupled to the diversity receiver module and configured to compare the first radio wave signal with a reference value, and responsive to the comparison, signaling the diversity receiver module to select a second radio wave signal from a second antenna to be provided as input into the audio system.

2. The system of claim 1, wherein the first radio wave is selected based on its intensity being higher than at least one other radio wave signal.

3. The system of claim 1, wherein the result of the comparison is the first radio wave signal intensity is greater than a predetermined intensity value.

4. The system of claim 1, wherein the comparator is part of the diversity receiver module.

5. The system of claim 1, further comprising:
an amplifier coupled to an output of the diversity receiver module and adapted to be coupled to an audio system.

6. The system of claim 1, wherein at least one of the antennas is a glass antenna.

7. The system of claim 1, wherein at least one antenna receives Frequency Modulation (FM) radio wave signals.

8. A method of controlling a radio receiver, comprising:
receiving a plurality of radio wave signals from a plurality of antennas;
selecting a first radio wave signal from a first antenna to be provided as input to an audio system; and
comparing the first radio wave signal with a reference value, and responsive to the comparison,
selecting a second radio wave signal from a second antenna to be provided as input into the audio system.

9. The method of claim 8, wherein the first radio wave signal is selected based on its intensity being higher than at least one other radio wave signal.

10. The method of claim 8, wherein the result of the comparison is the first radio wave signal intensity is greater than a predetermined intensity value.

11. The method of claim 8, wherein at least one of the antennas is a glass antenna.

12. The method of claim 8, wherein at least one antenna receives Frequency Modulation (FM) radio wave signals.
